(19) United States
(12) Patent Application Publication
(10) Pub. No.: US 2010/0156606 A1
(43) Pub. Date: Jun. 24, 2010

(54) RFID Sensor Assemblies and Methods of Use

(76) Inventor: Steven K. Gold, Lexington, MA (US)

Correspondence Address: ROBERT PLOTKIN, PC, 15 New England Executive Office Park, Burlington, MA, 01803, US

(21) Appl. No.: 12/479,463

(22) Filed: Jun. 5, 2009

Related U.S. Application Data
(60) Provisional application No. 61/203,186, filed on Dec. 19, 2008.

(51) Int. Cl. H04Q 5/22

(52) U.S. Cl. 340/10.4

(57) ABSTRACT

An embodiment of a RFID Sensor Assembly includes two or more RFID tags—an identifier tag and one or more sensor tags, each capable of providing output readable by a RFID tag reader. A processing system may identify, based on one or more signals received from the identifier and sensor tags, and/or the lack of receipt of such signals: (1) the identity of the Sensor Assembly and an associated object, and (2) a state of the Sensor Assembly and the associated object. Such “state” information may relate to whether the Sensor Assembly is, or has been, exposed to a particular prompt, e.g., an external input or trigger. Such prompts may relate, for example, to time, temperature, pressure, physical force or mechanical disruption.

### CROSS-REFERENCE TO RELATED APPLICATIONS

This application claims priority from co-pending and commonly-owned U.S. Provisional Patent Application Ser. No. 61/203,186, filed on Dec. 19, 2008, entitled, “RFID Sensor Assembly,” which is incorporated by reference herein.

### BACKGROUND

Radio frequency identification (RFID) relates to systems and methods used to facilitate the identification of objects (including people). A RFID tag (also called a transponder) may be attached to an object, and may be read by a RFID tag reader (also called an interrogator). Many RFID tag and reader products and technologies are available, and being developed, to address a variety of practical applications.

A RFID tag is an object that uses electromagnetic energy (radio waves) to interact with a RFID tag reader when the tag is within range of a compatible reader. Different RFID systems operate at different radio frequencies, and the frequency (and other factors) determine the range of a particular system (distance at which a tag may be detected by a reader of a particular RFID system). In general, a few frequencies in common use for RFID systems include low-frequency (around 125 KHz), high-frequency (13.56 MHz), and ultra-high-frequency or UHF (860-960 MHz). Microwave (2.45 GHz) is also used for some applications. One reason for the use of different frequencies for different RFID applications is because each frequency has different characteristics. For example, low frequency systems include tags that use less power and are better at penetrating non-metallic materials (e.g., fruit), however these tags can generally only be read at a range of up to a third of a meter away from a reader. High frequency tags are better for use with metal objects and have a read range of about one meter. Ultra High Frequency (UHF) tags provide even better range and faster data transfer rates, however they use more power and are less capable of transmitting signals through certain materials. In summary, different RFID systems operate at different frequencies and, as such, offer unique sets of operating characteristics that favor certain applications.

Many of today's RFID tags include an integrated circuit (e.g., silicon chip) used for storing and processing information, modulating and demodulating a signal, and other functions, coupled to an antenna used to transmit a signal. RFID tags that include a power source (e.g., battery) are called “active” RFID tags, and those that do not include a power source (e.g., battery) are called “passive” RFID tags. Semi-active RFID tags (e.g., battery assisted, also known as semi-passive RFID tags) and beacon RFID tags (those capable of transmitting a signal autonomously) also exist. Another type of RFID tag, the “chipless” RFID tag, is likely to play an increasing role in the future. With the advent of printable circuit technology, RFID tags that are printable directly onto surfaces of (or embeddable within) objects have become a reality.

Printed and chipless RFID tags provide low cost and versatility, and they are likely to become more and more desirable for certain consumer, commercial and industrial object identification applications. It is estimated that chipless RFID tags will dominate the market for RFID tags within the next ten years, with the production of more than a quarter trillion tag units per year by the year 2018 (Source: Printed and Chipless RFID Forecasts, Technologies and Players 2008-2018, by Raghu Das and Peter Harrop, published by IDTechEx, 2008). Several chipless RFID tag technologies are in development, including those that use nanometric particles with varying magnetic properties in order to create a device that can resonate and emit a distinct signal at close range, as well as chipless RFID tags that may be read at greater range.

RFID tags are read by RFID tag readers. RFID tag readers, in general, are capable of receiving signals from multiple compatible RFID tags that are located within the reception range of the particular RFID tag reader system, and that are consistent with the signal reception parameters of the particular RFID tag reader system. RFID reader systems vary, depending on their particular application and the RFID tags that they are intended to read. Furthermore, RFID tag readers are typically connected to some form of information processing system (e.g., computer hardware, software), which may be networked and may also include a database. Such information processing system may be used, for example, to process tag signals to provide useful (e.g., actionable) information. For example, such information processing system may associate specific RFID tag signal data with a particular object, and inform an operator or system whether or not such object is present or absent within a particular physical space based on whether or not specific RFID tag signal data is detected by a particular RFID tag reader. Such systems are commonly used for object tracking and inventory management applications. RFID tag and reader systems, along with their associated information processing systems, vary widely in order to accommodate a wide range of consumer, commercial and industrial applications.

A few examples of current RFID applications include: inventory management, manufacturing process component tracking and process optimization, consumer packaging, pharmaceutical packaging, tracking people, tracking livestock, pet identification, shipping container management, luggage processing, etc.

One major benefit of RFID technology is that RFID tags may be read by RFID tag readers through the use of radio waves, versus printed bar code technology that requires line-of-sight bar code readers. Another benefit of most RFID systems is their ability to read many distinct RFID tags quickly. RFID systems may also be designed (based on the specifications of the particular tags and readers) to read tags that are either nearby, or at a significant distance. Such versatility makes RFID systems useful for identification and tracking of a wide range of objects—including people and assets—in many environments.

### SUMMARY

The present invention relates to radio frequency identification (RFID) devices, systems and methods, and more particularly, to RFID Sensor Assemblies capable of concurrently identifying an object and also providing data about a state of the object. RFID Sensor Assemblies of the present invention are made of two or more RFID tags—for example, an identifier tag and one or more sensor tags each one capable of providing a signal readable by a RFID tag reader—and related methods of use. In one embodiment, a RFID Sensor Assembly includes inexpensive printable RFID tags, including a single identifier tag and a single sensor tag. In such an embodiment, the sensor tag, upon sensing a prompt (e.g., temperature above some predefined threshold), changes state from a first state to a second state, and ceases to be capable of transmitting its signal. An associated RFID tag reader may detect the identifier tag signal of the RFID Sensor Assembly that indicates the presence of the particular RFID Sensor Assembly within a particular space, and the associated RFID reader may also separately interrogate the sensor tag signal of the RFID Sensor Assembly to determine the state of the RFID Sensor Assembly relative to the particular parameter that is being sensed by such element of the RFID Sensor Assembly. For example, in the aforementioned embodiment, if a sensor tag signal is detected, then this may mean that a temperature that is being sensed by such sensor tag has remained below the predetermined threshold (and if the sensor tag signal is not detectable then it may mean the temperature rose above the predetermined threshold). Many RFID Sensor Assembly embodiments are possible, including those that use different tag components and technologies, those that include multiple sensor tags, those that sense any one or more of a wide range of sensible inputs (e.g., relating to time, temperature, physical forces), and those that interact with a variety of RFID reader systems and information processing systems.

### BRIEF DESCRIPTION OF THE DRAWINGS

FIG. 1 shows a representation of an embodiment of a RFID Sensor Assembly of the present invention.

FIG. 2a shows a representation of an embodiment of a RFID Sensor Assembly of the present invention in communication with a RFID tag reader and information processing system.

FIG. 2b shows an embodiment of a possible database structure for use with an information processing system of an embodiment of the present invention.

FIG. 3 shows a representation of an embodiment of a first method of the present invention.

FIG. 4 shows a representation of an embodiment of a printed RFID tag of the present invention printed onto a package, including its sensor tag being positioned across a seal of the package.

FIG. 5 shows a representation of an embodiment of the present invention that may be used as a luggage tag for securing an inspected unit of luggage following a security inspection.

FIG. 6 shows a representation of an embodiment of an identification and notification device implemented according to the present invention.

FIG. 7a shows a representation of an embodiment of another method of the present invention

FIG. 7b shows a representation of an embodiment of yet another method of the present invention.

FIG. 8 shows a representation of an embodiment of yet another method of the present invention.

### DETAILED DESCRIPTION

The present invention relates to radio frequency identification (RFID) devices, and more particularly, to RFID Sensor Assemblies made using two or more RFID tags—e.g., functional elements that are capable of transmitting distinct signals—and related systems and methods of use.

Whereas RFID devices of the prior art are directed to unique identification of tagged objects, the present invention is directed to systems and methods that use a RFID Sensor Assembly (Sensor Assembly), made of two or more RFID tags, to concurrently provide information relating to an identity of a particular RFID Sensor Assembly (and by extension the object such assembly is attached to), and information relating to the state of the RFID Sensor Assembly (and by extension the object such assembly is attached to).

As used herein, the term “tag” means a functional element which can transmit a unique electromagnetic (e.g., radio) signal that is readable by a compatible RFID reader, whether or not such functional element is physically discrete or shares physical elements (e.g., battery, antenna, processor) with other such RFID tags (or other components) of an embodiment of a RFID Sensor Assembly of the present invention. In one possible embodiment of the present invention, for example, two distinct tags, each one capable of transmitting a distinct electromagnetic signal, may be used. In another possible embodiment of the present invention, for example, a single device may transmit two or more distinct electromagnetic signals, such that each distinct transmission-capable element (each one herein defined as a tag) may be either enabled (capable of transmitting its distinct signal) or disabled (incapable of transmitting its distinct signal). The ability of a tag to transmit its distinct signal may be controlled by any of a variety of means, depending on the tag type and particular application, including but not limited to: controlling a tag's power supply, or connecting or disconnecting a tag from an antenna, for example. An active tag may actively transmit a signal that is receivable by a compatible RFID reader system within range of such a tag. Alternatively, a passive tag may be interrogated (energy is transmitted to the tag), in response to which such a passive tag may resonate or otherwise produce a signal that is receivable by a compatible RFID reader system within range of such a tag. In general, distinct tags produce distinct electromagnetic signals that may be correlated with a unique identity of the particular tag.

Relating to this, a RFID tag reader may scan (e.g., interrogate) for signals and receive any compatible signals that are transmitted by RFID tags located within reception range of the RFID reader. A RFID tag reader system may include some form of scanning logic, such as a scan for certain signals or types of signals as a precondition to searching for other signals or other types of signals. For example, a RFID reader may scan for signals associated with certain tag types (e.g., sensor tags, as described below) only if signals associated with certain other tag types (e.g., identifier tags, as described below) have already been received by the reader. In this case, the reader may scan, for example, for sensor tag signals in response to receipt of identifier tag signals. If an identifier tag signal is not received by the reader, the reader may not scan for sensor tag signals. In this way, receipt of identifier tag signals may serve as a precondition for the reader to scan for sensor tag signals, which may be useful in tag rich (high tag density) environments and for certain high-throughput applications.

Physical association of a RFID Sensor Assembly and a physical object may be by means of attachment of the RFID Sensor Assembly to the physical object, such as by using an adhesive, mechanical connecting means, or even by printing of a RFID Sensor Assembly (some or all of its components) directly onto an external or internal surface of an object. Other means of association, attachment and approximation may be used. Embodiments of RFID Sensor Assemblies of the present invention may be embedded or built into an object. Embodiments of RFID Sensor Assemblies of the present invention may be self-contained units, or may possibly have components distributed about an object to sense prompts at different locations on (or within) the particular object.

Embodiments of the present invention accomplish combined identification and sensing through the novel combination of an “identifier tag” with one or more “sensor tags,” whereby, for example, each sensor tag may exist in one of two possible states—a first state or a second state. The sensor tag state changes in response to a prompt (e.g., an input or trigger). In one embodiment, a sensor tag starts in a first state and then, following and in response to a prompt, transitions to a second state. For example, in one possible embodiment of a sensor tag, the sensor tag transmits (is capable of transmitting) a signal in a first state, but does not transmit (is incapable of transmitting) a signal in a second state. In another possible embodiment of a sensor tag, the sensor tag does not transmit (is incapable of transmitting) a signal in a first state, but does transmit (is capable of transmitting) a signal in a second state. In a third possible embodiment, a sensor tag signal changes in some way in response to a prompt, rather than being enabled (made capable of transmitting a signal) or disabled (made incapable of transmitting a signal), for example. Such a signal change may relate to a signal's electromagnetic profile, information, timing, frequency, amplitude, or other signal-related characteristic, or combination of characteristics. Additionally, in certain embodiments of the present invention, the operation, functions or functionality of a particular identifier tag or sensor tag may be shared or swapped with other identifier tags or sensor tags, possibly by virtue of an integrated circuit, shared components, or other means of association.

It should be noted that the labels “identifier tag” and “sensor tag” are used for descriptive purposes and do not limit the potential functionality of an embodiment of a tag of the present invention. For example, an embodiment of an identifier tag may also provide a sensing function, or an embodiment of a sensor tag may also provide an identification function (representative embodiment is described below). In other words, in some embodiments of a RFID Sensor Assembly of the present invention, a first tag will solely provide an identification function and a second tag will solely provide a sensing function, whereas in other possible embodiments a RFID Sensor Assembly of the present invention, a first tag may provide identification and sensing functions and a second tag may provide identification and sensing functions.

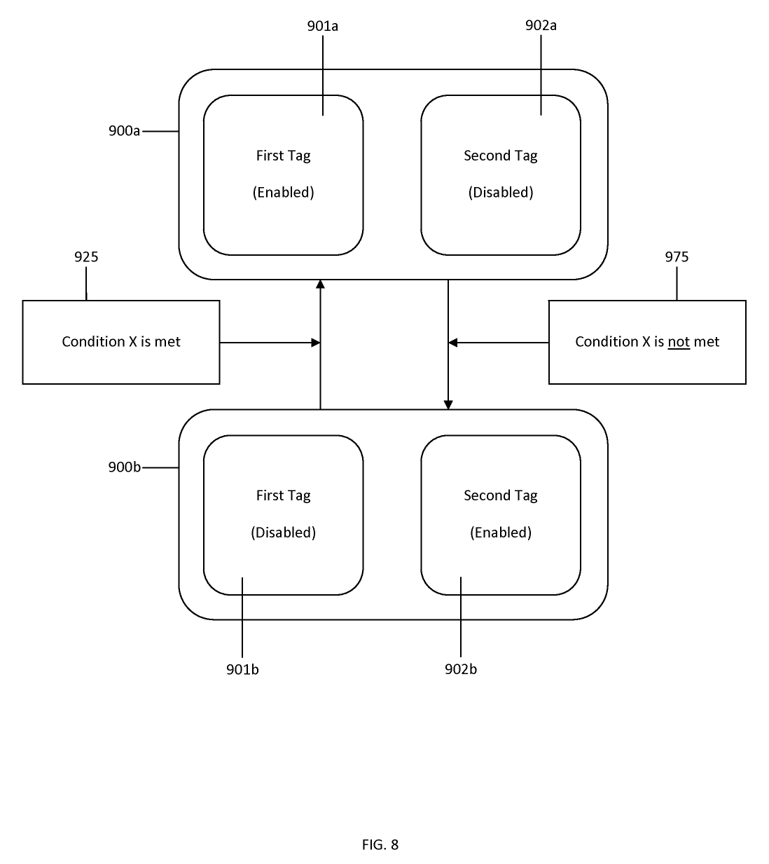

Although embodiments of RFID Sensor Assemblies of the present invention may use one identifier tag, they may also use multiple sensor tags, or even multiple identifier tags. If they use multiple sensor tags, and if at least one of the sensor tags is always enabled, then a set of such sensor tags may collectively serve as an identifier tag, for example, in which case a separate identifier tag may not be necessary. For example, an embodiment of the present invention may use two sensor tags, one of which is enabled when the ambient temperature is greater than or equal to 50 degrees, and the other of which is enabled when the ambient temperature is less than 50 degrees. In this case, combination of two such sensor tags may serve as a single identifier tag, because at least one of the two sensor tags is enabled (capable of transmitting a signal) at any point in time, independent of temperature. In this case, the information processing system that identifies tag signals would be configured to recognize that the distinct signals capable of being transmitted by the different sensor tags are both instances of a single “virtual” identification signal transmitted by the single “virtual” identifier tag represented by the combination of two sensor tags. A detailed example of such functionality is disclosed below in connection with FIG. 8.

In some embodiments, a sensor tag transition from first state to second state may be unidirectional (e.g., irreversible); in other embodiments a sensor tag state transition may be reversible, either once or multiple times (e.g., may switch back and forth). For clarity, the state (first or second) of a sensor tag corresponds to whether or not a particular sensor tag has experienced (or is experiencing) the specific prompt to which such sensor tag is responsive. Whether this enables or disables a sensor tag's ability to transmit a signal following (or during the presence of) a particular prompt is specific to the intended use, design and manufacture of a particular sensor tag embodiment. Different embodiments of individual sensor tags may be constructed and used to respond to different prompts, for example, and may also have signal transmission either enabled or disabled following such a prompt. Since an embodiment of a RFID Sensor Assembly of the present invention may be made of one or more sensor tags, each tag may be independent and may operate differently. Different types of RFID tags are readable by different types of RFID tag reader systems, so compatibility between each tag and a reader is assumed for each of the representative embodiments and examples presented in this disclosure.

Prompts may represent any of a wide range of inputs that are capable of being sensed by a sensor tag of an embodiment of a RFID Sensor Assembly of the present invention. In one embodiment, a prompt may relate to an occurrence of a particular point in time (such as a particular time of day, or a particular combination of date and time of day, or a particular point in time falling within a predetermined range of times), or a lapse of a predetermined amount of time. In another embodiment, a prompt may relate to temperature. In yet another embodiment, a prompt may relate to a physical or mechanical force. In the case of a physical or mechanical force, such force could involve directly damaging, disabling or even partial or complete destruction (e.g., tearing) of an element of a sensor tag of a Sensor Assembly of the present invention to cause the sensor tag to become incapacitated and unable to transmit a signal, for example. Such a prompt may be caused, for example, by a force such as vibration, or also by a human touching or manipulation of an element of a sensor tag or related Sensor Assembly (e.g., activation by a person in need of assistance, for example). In general, prompts may relate to, for example: actual time, time lapse, physical or mechanical forces, deformation or destruction; temperature; pressure; humidity; exposure to a particular molecule or chemical agent; exposure to a particular environmental condition; exposure to radiation; or even an electrical input or signal from another device. It may be possible for an embodiment of a sensor tag to sense one or more prompts, either uniquely or in combination. As noted, prompts may be received as signals from external sensing devices, such as an electrical or mechanical signal received from a chemical detector. One example of a prompt is a temperature above 100 degrees Celsius. Another example of a prompt is a temperature below 15 degrees Celsius. Another example of a prompt is a force that exceeds 3 g's. Another example of a prompt is a period of time that exceeds 60 days from an established starting date. Another example of a prompt is a physical deformation that breaks or disables an element of a sensor tag. Another example of a prompt is physical destruction that breaks or disables an element of a sensor tag. Another example of a prompt is an electrical or other signal from an external source. As may be seen from these examples, sensor tags may be implemented according to the present invention in a variety of ways to sense and communicate useful information.

A sensor tag may respond (transition from one state to another) based on the initial sensing of a prompt (e.g., a temperature that rises above some threshold), or may respond in real-time during the time when a condition exists (e.g., a temperature that is currently above some threshold as sensed by the particular sensor tag) and may change its state (e.g., between first and second) accordingly. In this last example, a sensor tag may transition between its states depending on whether or not the prompt condition is being met in real time, and as a result facilitates provision of real-time information about the state of a RFID Sensor Assembly and associated object. A wide range of prompts, and combinations of prompts, may be sensed by individual sensor tags to provide benefits for a wide range of applications.

A prompt causes a change of state of a sensor tag for a sensor tag that is responsive to such a prompt. In certain embodiments of the present invention, a single sensor tag may have the potential to undergo multiple state changes due to multiple prompts. In such a case, a first prompt that causes a first change in a state of a sensor tag, and a second prompt that causes a second change in the state of the sensor tag, may be instances of the same or different prompt from each other. For example, two prompts, each of which consists of a force of 3 g's, but applied at two different times, would be examples of two instances of the same prompt. As another example, a first prompt consisting of a force of 3 g's, and a second prompt consisting of a drop in temperature below a threshold of 50 degrees, would be instances of different prompts. Different prompts may differ from each other in any of a variety of ways, such as by differences in their units of measure, magnitude, quantity, direction, or any combination thereof.

One possible embodiment of a RFID Sensor Assembly implemented according to the present invention may be used to enable RFID identification of a package of frozen food, and may sense and communicate (with a RFID tag reader system) whether or not such package has been exposed to a temperature above a certain predefined threshold that indicates possible thawing. In another possible embodiment, a RFID Sensor Assembly implemented according to the present invention may be used to identify a unique package of medication (e.g., pharmaceutical or biological), and whether or not it is within the expiration date of its contents, which may indicate whether or not the medication is safe for use. In yet another possible embodiment, a RFID Sensor Assembly implemented according to the present invention includes a sensor tag that is attached to (e.g., positioned over) the seal of a container (e.g., package, shipping container, bag, luggage). In this last example, when the seal of the container is compromised, such as when the container is properly opened or otherwise compromised, a sensor tag of such an embodiment may be made and attached to the container in a manner whereby it becomes physically altered, thus transitioning from a first state to a second state, and in the process (in one possible embodiment of such a RFID Sensor Assembly of the present invention) such a sensor tag would lose its ability to transmit a signal, thereby indicating that the seal has been compromised. Each of the representative embodiments includes both an identifier tag and a sensor tag (the functions of which may be shared or swapped) to enable both the identification of a RFID Sensor Assembly of the present invention (and presumably the object it is attached to), as well as information relating to whether or not a prompt has been sensed by a sensor tag of the particular RFID Sensor Assembly, which conveys new and useful information about the state of the RFID Sensor Assembly (and presumably the object it is attached to). The general concept of combining an identifier tag and one or more sensor tags in an assembly is beneficial for a wide range of consumer, commercial and industrial applications.

Embodiments of the present invention are intended as a way to use existing and future RFID tag and reader technologies, and associated information processing systems, in new ways in order to enable the communication of useful information beyond the simple identification of a tag or object. Embodiments of RFID Sensor Assemblies of the present invention may convey information about (a) the presence or absence of a particular RFID Sensor Assembly (and an associated object) within a physical space being monitored by a compatible RFID tag reader system, and (b) if such RFID Sensor Assembly of the present invention is present (e.g., within range of the reader), then the RFID Sensor Assembly further provides information about its state (and, by extension, the state of an associated object). While embodiments of a RFID Sensor Assembly may include a single sensor tag that reacts to a single parameter of interest, other embodiments of a RFID Sensor Assembly may include multiple sensor tags that respond to the same or other (multiple or different) parameters. In addition, various embodiments of RFID Sensor Assemblies may incorporate one or more RFID tag technologies.

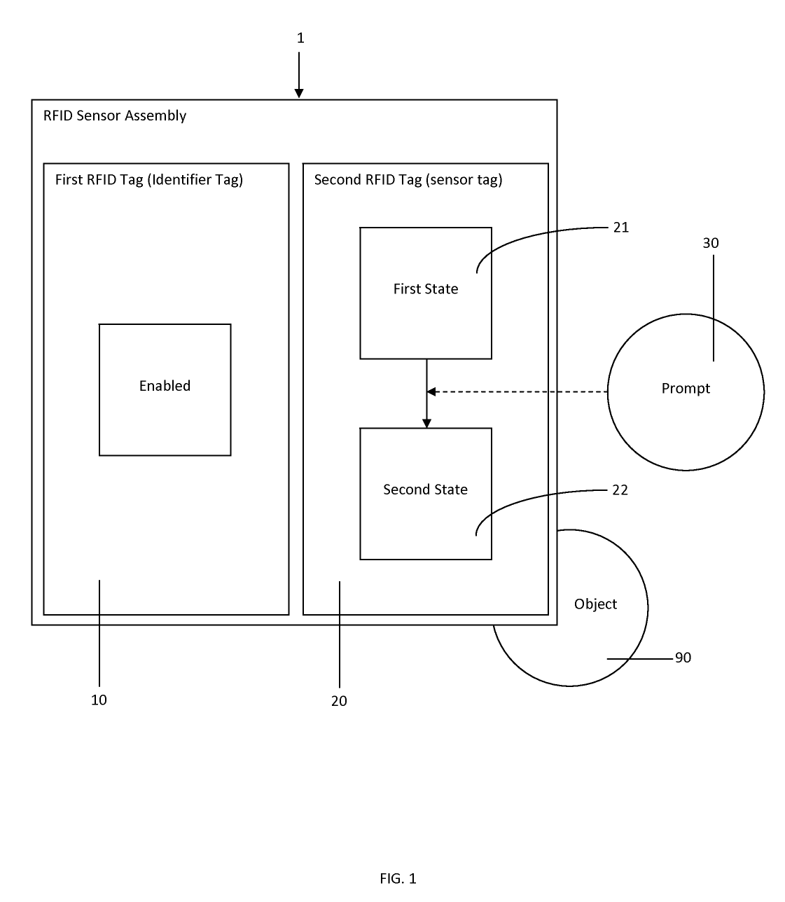

FIG. 1 shows a representation of an embodiment of a sensor assembly of the present invention. In this particular embodiment, RFID Sensor Assembly 1 includes two RFID tags, an identifier tag 10 and a sensor tag 20. In this embodiment, identifier tag 10 is capable of transmitting a signal that may be read by a compatible RFID tag reader. Sensor tag 20 exists in a first state 21 which may be transitioned to a second state 22 in response to a prompt 30. In a first possible representative embodiment of sensor tag 20 of the present invention, if first state 21 of sensor tag 20 enables signal transmitting capability of sensor tag 20, then the second state 22 following prompt 30 disables signal transmitting capability of sensor tag 20, possibly by rendering sensor tag 20 incapable of transmitting the signal. Alternatively, in a second possible representative embodiment of sensor tag 20 of the present invention, if first state 21 of sensor tag 20 disables signal transmitting capability of sensor tag 20, then the second state 22 following prompt 30 enables signal transmitting capability of sensor tag 20. Reading of a RFID tag by a RFID tag reader requires that a given RFID tag is within reception range of a compatible RFID tag reader system. Thus, when a RFID Sensor Assembly 1 is within range of a RFID tag reader system (such that the RFID Sensor Assembly's identifier tag signal is capable of being read), the RFID tag reader system will also be able to detect the RFID Sensor Assembly 1 sensor tag 20 signal in order to determine the state of RFID Sensor Assembly 1, which will generally correspond to the state of associated object 90. For clarity, a state (e.g., first, second) wherein a tag signal transmission capability is enabled (such as when a prompt enables signal transmitting capability of a sensor tag) may mean (i) that an active tag is transmitting a signal (e.g., continuously, intermittently), or (ii) that a passive tag is capable of transmitting a signal upon interrogation by a compatible RFID tag reader system. For clarity, a state (e.g., first, second) wherein a tag signal transmission capability is disabled (such as when a prompt disables signal transmitting capability of a sensor tag) may mean (x) that an active tag does not transmit a signal while it is disabled, or (y) that a passive tag does not transmit a signal while it is disabled. In the case of a disabled passive tag of the present invention, such disabled state may be due to an element of such a passive tag causing the tag's transmission capability to be turned off, or possibly because the passive tag has been disabled, such as by physical deformation or destruction, for example. It should also be noted that while a tag of the present invention may involve enabling and disabling signal transmission, it may also be possible and within the scope of the present invention to alternatively alter the electromagnetic profiled of a signal in lieu of enabling and disabling signal transmission, as a means for communicating information. Both of these situations and related representative embodiments are described in more detail below.

As noted, a variety of prompts 30 are possible to cause sensor tag 20 to change between a first state and a second state. In one embodiment, prompt 30 may be a mechanical force that causes a physical alteration (e.g., the destruction of an element) of sensor tag 20 (and thus changes sensor tag 20 state from first state 21 to second state 22). In another embodiment, a particular temperature condition, once satisfied, may cause sensor tag 20 to transition from first state 21 to second state 22. Many other types of prompts 30 are possible, including but not limited to those relating to: physical force, real time, lapsed time, temperature, pressure, vibration, the presence or absence of a particular molecule or agent, an environmental condition, and more. RFID Sensor Assembly 1 of the present invention may be associated with an object 90, such as a container, box, package, bag, lock, seal or tape. In common use when a RFID Sensor Assembly 1 of the present invention is associated with (e.g., attached to) an object 90, the identity and state of a particular RFID Sensor Assembly 1 of the present invention may relate to (or correlate with) an identity and state of the particular associated object 90.

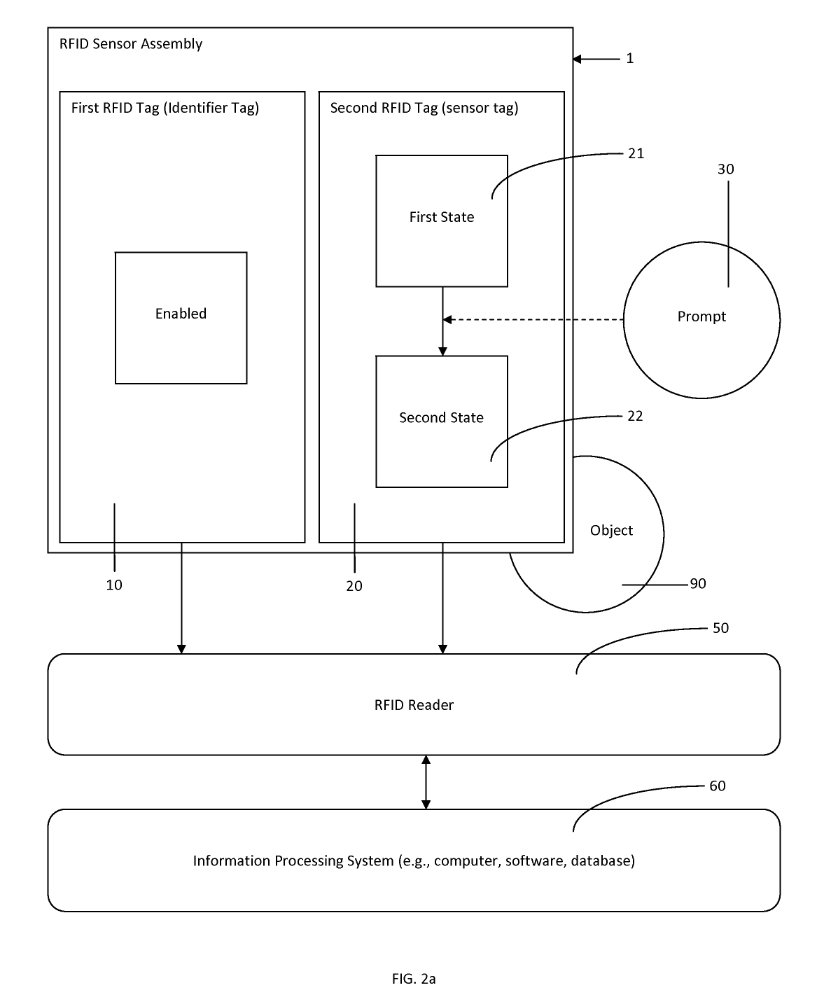

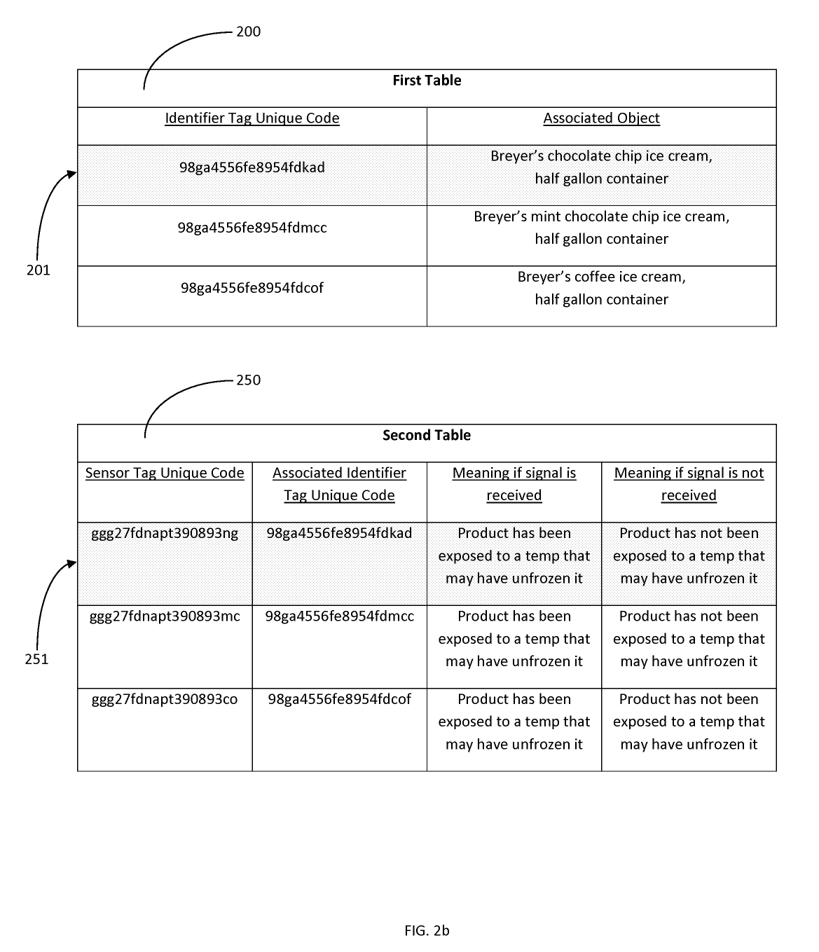

FIG. 2a shows a representation of an embodiment of a RFID Sensor Assembly 1 of the present invention shown in FIG. 1 in communication with a RFID tag reader 50 and associated information processing system 60. This Figure shows how a RFID tag reader 50 may, in an embodiment using passive RFID tags, for example, interrogate RFID Sensor Assembly 1 by separately interrogating identifier tag 10 and sensor tag 20 to learn the particular identity of RFID Sensor Assembly 1 (via identification of identifier tag 10 identity), and state of RFID Sensor Assembly 1 (via whether a sensor tag 20 signal is received or not, for example), respectively. Such information, once received by RFID tag reader 50, may be communicated to an information processing system 60, which may be integrated with or separate from RFID tag reader 50 system. An information processing system 60 may include hardware and software, possibly including a database. Information in a database may, for example, help correlate tag signal information (received by RFID tag reader 50 and processed by information processing system 60) with information relating to: the type of tag being detected (and associated prompt for any sensor tag 20), and the identity of object 90 that a particular RFID Sensor Assembly 1 is associated with. Information provided by a database may, in one embodiment of the present invention, be used to correlate RFID tags (both identifier tags 10 and sensor tags 20 of the present invention) with a unique object or with one another in order to provide awareness that unique tag signals are associated with the same RFID Sensor Assembly 1 (and associated object 90) of the present invention. Information processing system 60 may, in turn, provide information to a related operator, system, network, computer, etc. In such an embodiment of RFID Sensor Assembly 1 of the present invention, information may be used, for example, not only to learn if a particular RFID Sensor Assembly 1 (and associated object 90) is present within a particular space or environment, but also, if it is present, the state of the particular RFID Sensor Assembly 1 (and associated object 90). For example, an embodiment of a RFID Sensor Assembly 1 may inform an operator if a particular package has been opened, exposed to a temperature below some pre-determined threshold, mishandled, and more. By enabling a change to the state of a sensor tag 20 of a RFID Sensor Assembly 1, information relating to RFID Sensor Assembly 1 and associated object 90 may be learned and applied. Understanding both the identity and state of RFID Sensor Assembly 1 enables a wide range of practical applications.

FIG. 2b shows a representation of one possible embodiment of a database structure having two tables first table 200 and second table 250. First table 200 shows identifier tag unique identification codes and the associated objects for each such code. Second table 250 shows sensor tag unique identification codes and corresponding information, including which identifier tag each sensor tag is associated with (which also provides information by means of a relational database about the object which a particular sensor tag is associated with), along with (a) the meaning if a signal is received from a particular sensor tag, and (b) the meaning if a signal is not received by the same particular sensor tag. For example, first entry 201 shown in first table 200 of FIG. 2b shows that a particular identifier tag has an identification code that is “98ga4556fe8954fdkad” and is associated with a particular object that is identified as “Breyer's chocolate chip ice cream, half gallon container.” Continuing with this example, first entry 251 shown in second table 250 of FIG. 2b shows that a particular sensor tag is associated with identifier tag having identifier tag code 98ga4556fe8954fdkad (and, by extension, the object that this identifier tag is associated with), and additionally that (a) if a signal is received from this particular sensor tag it means that the sensor tag has been exposed to a temperature above a predetermined threshold (e.g., one that would mean that the product has been unfrozen or otherwise unsuitable for consumption), and (b) if a signal is not received from this particular sensor tag it means that the sensor tag has not been exposed to a temperature above a predetermined threshold and remains suitable for consumption. It should be noted that in this example, the Sensor Assembly may also include a second sensor tag that responds to lapsed time in order to determine if the associated object—the ice cream product—has gone beyond its freshness date, for example. Other multiple sensor tag assemblies are also possible.

The particular database structure shown in FIG. 2b is merely an example and does not constitute a limitation of the present invention. Alternative data structures may be used to represent the same information or other information for producing the same results. Furthermore, means other than databases may be used to store information about identifier tags, sensor tags, and associated objects.

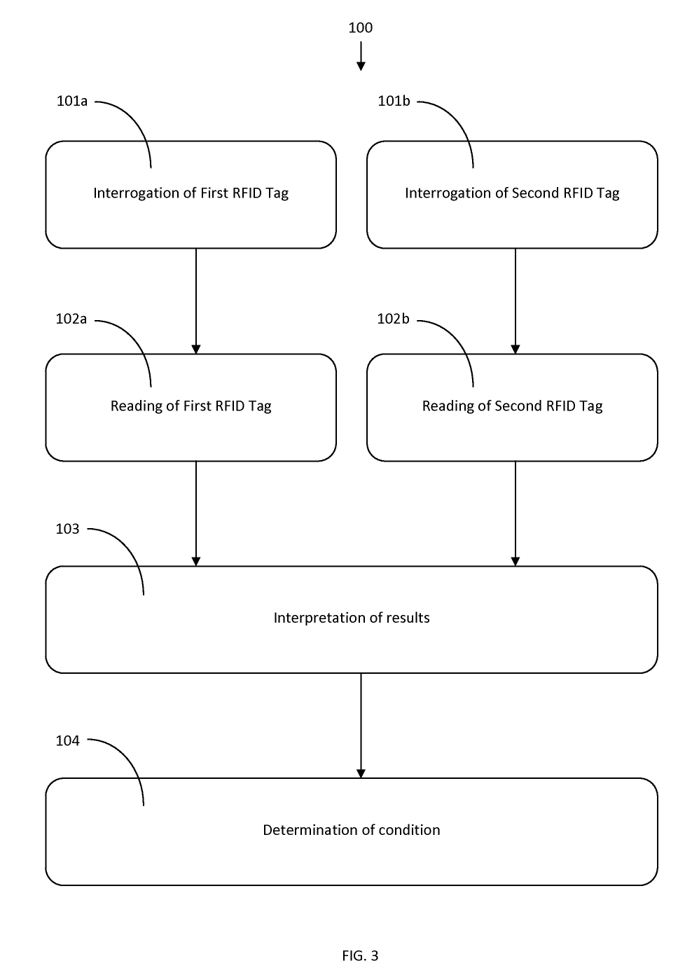

Systems of the present invention may be used in many ways. In one embodiment of a method 100 of the present invention, as shown in FIG. 3, a passive identifier tag is interrogated 101a and read 102a by an appropriate RFID tag reader. At generally the same time, a passive sensor tag is interrogated 101b and read 102b by the (same, or different but affiliated) RFID tag reader. In this example, the term “read” means that the RFID tag reader either receives a signal from a tag, or receives no signal (which may nevertheless still convey information to the reader). The information read includes unique signal data for an identifier tag, which corresponds to the particular RFID Sensor Assembly. The information read also includes data relating to the state of a sensor tag (by virtue of whether it is transmitting a unique signal, or not). This information may then be communicated to an information processing system that interprets the information 103, e.g., whether RFID Sensor Assembly has experienced a particular condition known to be detectable by the particular RFID Sensor Assembly according to information available to the information processing system. Information interpretation 103 may be performed, for example, by accessing data stored in a database having a database structure similar to the database structure shown in FIG. 2b, or elsewhere. In this particular embodiment, this leads to a determination of the state of the RFID Sensor Assembly 104, e.g., whether or not the sensor tag has been exposed to a particular prompt or condition. This may be assumed to correspond to the state of an object with which the particular RFID Sensor Assembly is associated. In one possible variation of an embodiment of a method of the present invention, the first step may not be needed if, for example, first and second RFID tags are active tags capable of independent transmission of a signal. Furthermore, in another possible embodiment, a combination of tag types may be used, e.g., a sensor assembly may include both passive and active RFID tags. Embodiments may also include multiple sensor tags that monitor and respond to one or more prompts, e.g., the concept may be scaled.

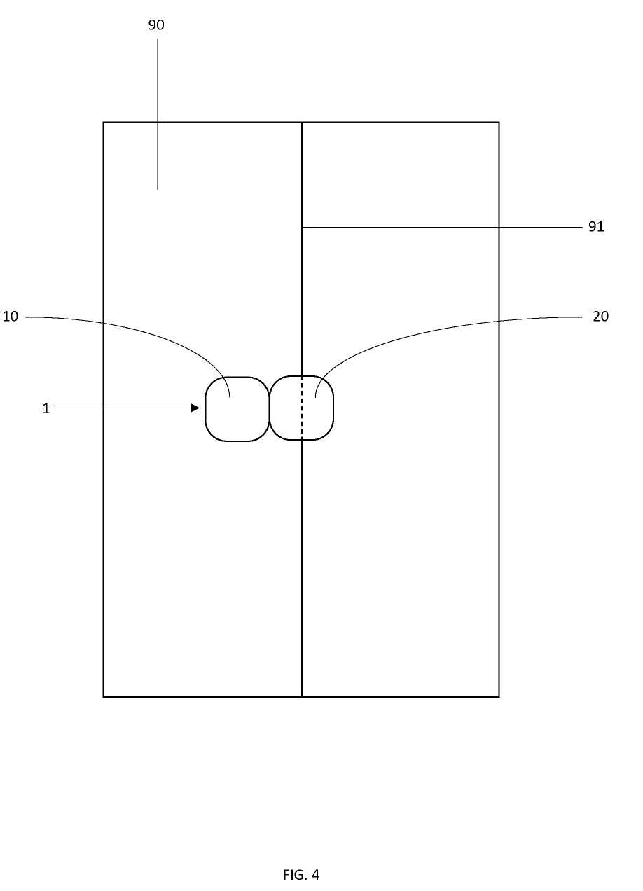

As a practical example of an embodiment of RFID Sensor Assembly 1 of the present invention that may be useful for detecting if a seal 91 of an object 90, such as a package (e.g., container, box, envelope), has been compromised (e.g., opened), a RFID Sensor Assembly 1 may have a general layout as shown in FIG. 4. Such an embodiment of RFID Sensor Assembly 1 may include, for example, two passive RFID tags that are, as a unit, applied to—or printed or otherwise or manufactured onto or into—an object 99 (e.g., package) of the example. In one possible embodiment, RFID Sensor Assembly 1 may have an adhesive, or be combined with a material that includes an adhesive (e.g., sticker, tape), as a means of physically attaching RFID Sensor Assembly 1 to object 90. In another possible embodiment, some or all elements of a RFID Sensor Assembly 1 may be printed directly onto an internal or external surface of object 90 using printed electronic circuit printing means. Other means of adherence, attachment, or integration of RFID Sensor Assembly 1 and object 90 are possible. In one possible embodiment, identifier tag 10 may be positioned in such a way that it remains secure and capable of transmitting its signal, while sensor tag 20 may be designed and positioned to be physically disabled (e.g., in a controlled manner) if seal 91 of object 90 is broken. In this example, sensor tag 20 physically lies across seal 91 being monitored. In such an embodiment, sensor tag 20 is intact and capable of transmitting a signal when object 90 seal 91 is intact (e.g., unbroken). When seal 91 is broken (the prompt), and sensor tag 20 of this embodiment is physically broken, as well, sensor tag 20 becomes disabled and incapable of transmitting a signal. In this example, sensor tag 20 first state 21 provides for transmission of a signal by sensor tag 20, sensor tag 20 second state 22 does not allow transmission of a signal by sensor tag 20, and prompt 30 is the physical disruption of object 90 seal 91 that concurrently physically destroys a critical element of sensor tag 20 to thereby disable sensor tag 20 and cause it to become incapable of transmitting its signal. This may be accomplished, for example, by having sensor tag 20 designed and positioned such that its antenna becomes disconnected or damaged due to prompt 30, for example. In the case of a printed RFID tag, the printed tag could include a design feature that promotes controlled incapacitation of the particular RFID sensor assembly 1 sensor tag 20 when subjected to a prompt 30. Relating to this example, when RFID Sensor Assembly 1 associated with object 90 is within reception range of RFID tag reader 50, RFID tag reader 50 is capable of interrogating RFID Sensor Assembly 1 and learning whether or not the particular object 90 seal 91 is intact (since the RFID tag reader is capable of detecting signals from both identifier tag 10 and sensor tag 20). If object 90 seal 91 is not intact and sensor tag 20 is not transmitting its signal (but identifier tag 10 is transmitting its signal), then RFID tag reader 50 is capable of interrogating RFID Sensor Assembly 1 and (in likely combination with an information processing system) learning that the particular object 90 seal 91 has been compromised (since, in this case, RFID tag reader 50 will receive a signal from identifier tag 10, but not from sensor tag 20 since sensor tag 20 has been disabled and made incapable of transmitting its signal). In this way, an embodiment of RFID Sensor Assembly 1 of the present invention may be used to provide information relating to identification of a particular RFID Sensor Assembly 1 (and associated object 90, such as a package as shown in FIG. 4), as well as the state of the RFID Sensor Assembly 1 (and associated object 90, such as a package as shown in FIG. 4). Various embodiments of a RFID Sensor Assembly of the present invention may be used in combination with a wide range of containers (and other objects) and their sealing or closure means, in order to provide information relating to both the identity of a particular container (or other object) and the state of its sealing or closure means, e.g., whether or not such sealing or closure means is intact. Examples of containers and other objects that may benefit from embodiments of the present invention include, but are not limited to: containers, shipping containers, packages, boxes, bags, money bags, envelopes, and physical structures having openings with closures. Examples of sealing or closure means that may be useful in combination with the present invention include but are not limited to: lock attachment points, locks, cables, wire, string, tape, stickers, tags, latches, clasps, snaps, connectors and securing means.

Systems and methods of the present invention may be applied in a variety of ways. In one example, as represented in FIG. 4, an embodiment of a RFID Sensor Assembly of the present invention may include a breakable sensor tag, whereby physically breaking the sensor tag causes it to change from a first state whereby the sensor tag is able to transmit a signal, to a second state whereby the sensor tag is unable to transmit a signal. Such a RFID Sensor Assembly could be used, for example, with a container to provide information about whether (or not) a particular container has been opened or otherwise compromised. For example, the sensor RFID tag could be a chipless RFID tag printed onto the package, and could be applied at least partially over a flap or other opening of the package. If the flap or other opening remains sealed, the sensor tag of such a RFID Sensor Assembly remains intact, and both signals (from identifier tag and sensor tag) are detectable; otherwise, if the sensor tag is incapacitated and unable to transmit its signal, the RFID Sensor Assembly will transmit identifier information from the identifier tag, but no signal from the sensor tag. Thus, information about both the identity and state of the RFID Sensor Assembly is communicated. This also provides information about the package. This general type of an embodiment of the present invention, including its many possible variations, could be used to provide information about the identification and integrity of individual packages and containers, including large containers (e.g., shipping containers), wrapped pallets of product, individual containers (e.g., cardboard boxes full of product), individual consumer product packages, luggage, money bags, secure packages, envelopes, and sealed documents, for example. As discussed, many other uses are possible.

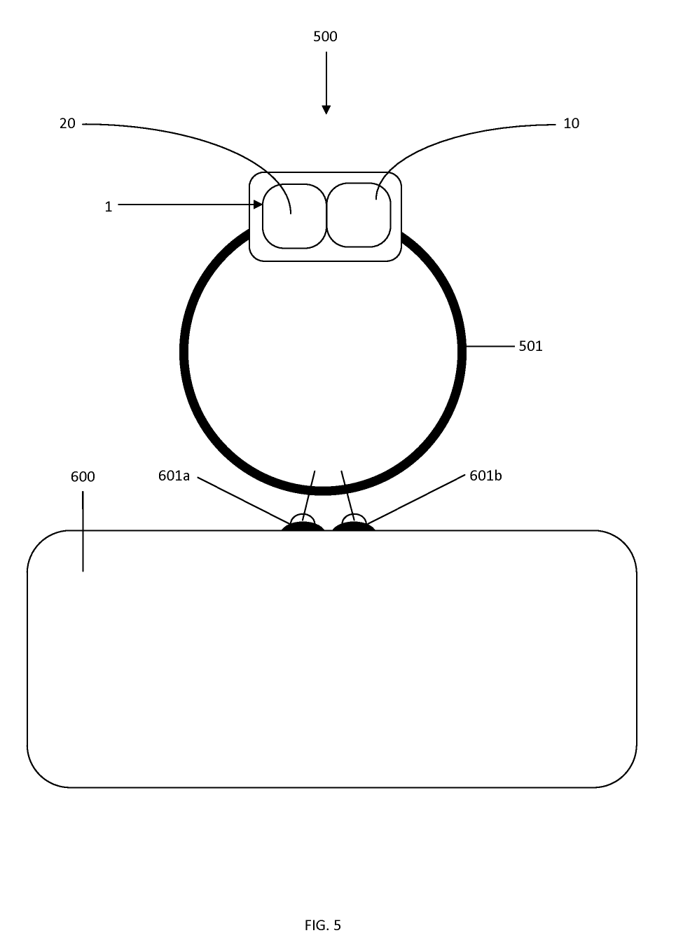

As another example of a practical application of the present invention, FIG. 5 shows a representation of an embodiment of a Sensor Assembly implemented according to the present invention that is a container seal 500 having a strap 501 that is attachable to a container 600. Container seal 500 includes identifier tag 10 and sensor tag 20. Container seal 500 strap 501 is, in one embodiment, capable of being looped through (or otherwise secured to) attachment points 601a and 601b of container 600, such as two zippers that join together on a piece of luggage (along the same seam, or zipper line). Alternatively, such an embodiment could be used to secure two lock insertion points that come together when a door is closed (such as a door of a shipping container). In one embodiment of container seal 500, when container seal 500 is secured (e.g., attached to a container 600) using strap 501, then sensor tag 20 is enabled (capable of transmitting a signal). In this same embodiment, when container seal 500 strap 501 is broken (e.g., cut), then sensor tag 20 becomes disabled (incapable of transmitting a signal). For example, the representative embodiment shown in FIG. 5 may include a sensor tag 20 antenna that is built into a strap 501 of container seal 500 such that when strap 501 is cut or broken in order to remove container seal 500 to permit the opening of secured container 600, sensor tag 20 is disabled (incapable of transmitting a signal) in this way—by means of destruction of its sensor tag 20 antenna. In another possible embodiment, strap 501 may incorporate a wire or connection that is critical to the operation (ability to transmit) of an associated sensor tag 20. In this way, such an embodiment of the present invention may be used for the practical application of securing a seal of a container and using RFID technology to communicate information about the presence of a container within a space that is being monitored by a RFID reader and, if a particular container is present, whether or not a container seal has been compromised (e.g., broken)—which may indicate that the container has been opened. Such an embodiment of the present invention could be used to secure and monitor luggage in transit within an airline baggage handling system (whereby a piece of luggage could be inspected and then sealed using a container seal implemented according to the present invention following a security check), for example. Furthermore, embodiments of a container seal implemented according to the present invention may be used to secure cargo doors; containers that are transported on trucks, trains, ships and aircraft; money bags or boxes; confidential documents that are packaged or wrapped to prevent unintended disclosure of their contents during delivery; packages containing pharmaceuticals or other controlled substances or materials; and many other applications. Embodiments of a container seal implemented according to the present invention may be made and used in a variety of ways. A container seal may be made using any of a diverse range of materials (e.g., plastic, metal), and may be fastened together (e.g., sealed) in any of a variety of ways, including by means of an adhesive or mechanical locking mechanism (e.g., locking snap or latch), for example. In one possible embodiment, a container seal implemented according to the present invention combines a lock, such as a padlock, cable lock or a combination lock, with an identifier tag and a sensor tag, whereby the sensor tag is enabled or disabled according to whether the lock is closed or open, respectively, for example. Such an embodiment may, for example, provide for detection and tracking of a lock, and determination of whether or not the lock is open.

Embodiments of a container seal implemented according to the present invention may include a sensor tag having an element (e.g., antenna, power supply, critical component) that is integrated with a part of the container seal that is breakable or separable, such that the breakage or separation (e.g., opening, release, tearing, destruction) of the container seal results in the disabling of the sensor tag, whereby it cannot transmit a signal. Sensor tag disabling means (e.g., the means by which a sensor tag's signal transmission capability is turned off) may include any of a variety of designs and structures that either physically disable or destroy the sensor tag, or disable or destroy a particular component or associated element, for example. In one possible embodiment, for example, a sensor tag antenna is physically separated to thereby disable signal transmission capability.

In another possible embodiment of a container seal implemented according to the present invention, an identifier tag is initially disabled (incapable of transmitting a signal), and then enabled (capable of transmitting a signal) when the seal is first secured to a container; and a sensor tag is enabled (its first state) at the time when the associated identifier tag is enabled, and then disabled (its second state) when a prompt occurs (e.g., breaking or separation of the seal). Such an embodiment permits provision of information relating to if (and possibly when) the container seal was secured to a container, and if (and possibly when) the container seal was broken or removed from the container. In practice, such an embodiment of a container seal may, once it has been secured (at which time identifier tag and sensor tag are enabled), communicate with a RFID reader system and associated information processing system to provide information relating to the fact that the container seal has been secured to an object, such as a piece of luggage being processed in an airport environment. This general type of an embodiment of a RFID Sensor Assembly may, for example, include a power supply and use active tag technology, and may include a switch that initially enables the embodiment (all tags) to be turned on—such that only one of the tags of such an embodiment is disabled following a prompt (e.g., physical disabling or destruction).

Other systems—or a human operator—may provide inputs or other information to the information processing system that relates details of a particular object to a particular RFID Sensor Assembly. A RFID reader system may then check the status of a container seal, for example, and determine whether or not it remains intact, e.g., whether or not the container seal has been broken. If the container seal has been broken or separated, this may indicate that the contents of a container may have been accessed or compromised, which may pose a security concern. In yet another embodiment of a container seal consistent with the present invention, an identifier tag may be initially enabled, and remain enabled, and an associated sensor tag may transition state twice, first when the container seal is secured to a container, and second when the container seal is disrupted or removed from the container. The second transition from the second state to third state would occur following a prompt such as the physical destruction or separation of the container seal. Embodiments of a container seal consistent with the present invention may be made using any of a variety of materials and RFID tag technologies, and may be designed and manufactured in any of a variety of ways, including as tags, loops and locks, for example, to address a wide range of practical container sealing and security applications.

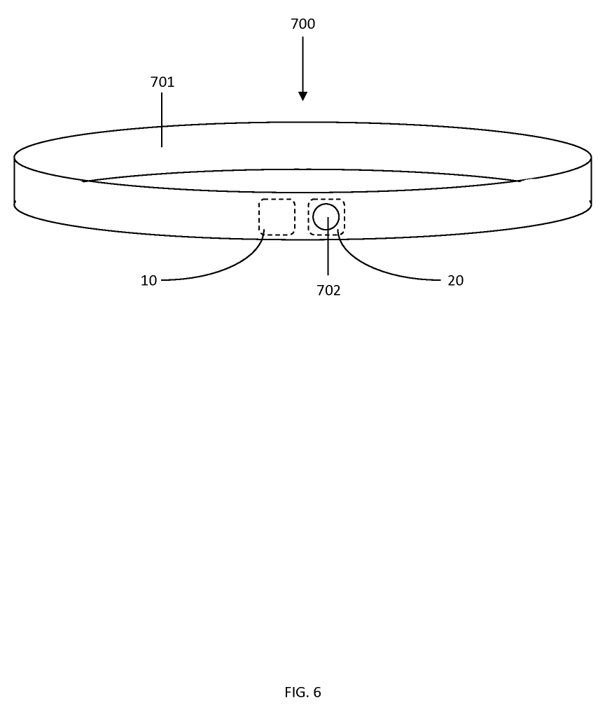

As another example of a practical application of a RFID Sensor Assembly implemented according to the present invention, shown in FIG. 6, an identification and notification device 700 has a wrist band 701 or other mechanism that enables attachment to a person, an identifier tag 10 that is always enabled, and a sensor tag 20 that changes state according to a prompt, such as when a person (to whom wrist band 701 or other object is attached) touches or depresses a button 702 or other element of such identification and notification device 700. For example, sensor tag 20 of an embodiment of identification and notification device 700 may be disabled (incapable of transmitting a signal), and then enabled (capable of transmitting a signal) when button 702 or other element is touched or depressed, the sensor tag 20 being responsive to a person's input by virtue of mechanical force, pressure, or the sensing of heat from a human digit, for example. Sensor tag 20 may be enabled for a period of time, such as several minutes (or possibly until it is manually disabled by a health care worker), to ensure detection by a RFID reader system, for example. Embodiments of such identification and notification device 700 implemented according to the present invention may have practical application in hospitals, nursing homes, and other health care facilities, for example, enabling health care workers to give such a device 700 to a person (e.g., patient), and for the person to be able to be identified and tracked (throughout the health care facility, for example) using RFID means, and also to be able to request assistance by simply touching button 702 or another element located on identification and notification device 700—enabling sensor tag 20 of device 700 (to transmit its signal) and alerting health care workers that the person is seeking assistance. Other sensors, such a force sensor, may be included in a similar embodiment implemented according to the present invention, to provide additional functionality, such as detection of falls. Sensor tags of various kinds may also be used to sense other physiologic parameters (or receive input from external sensors), and to alert health care workers if certain conditions are met, such as a heart rate that falls below (or rises above) a predetermined threshold. Triggers may be pre-established, or determined (or modified) for an individual patient, for example. As may be seen by these examples, identification and notification devices implemented according to the present invention provide valuable benefits relative to the tracking and monitoring of individuals in health care and other settings.

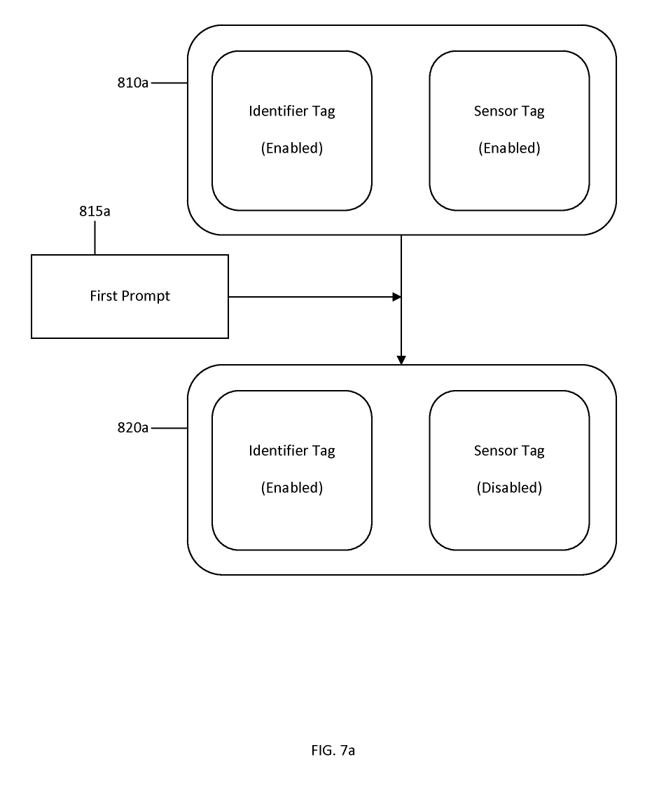

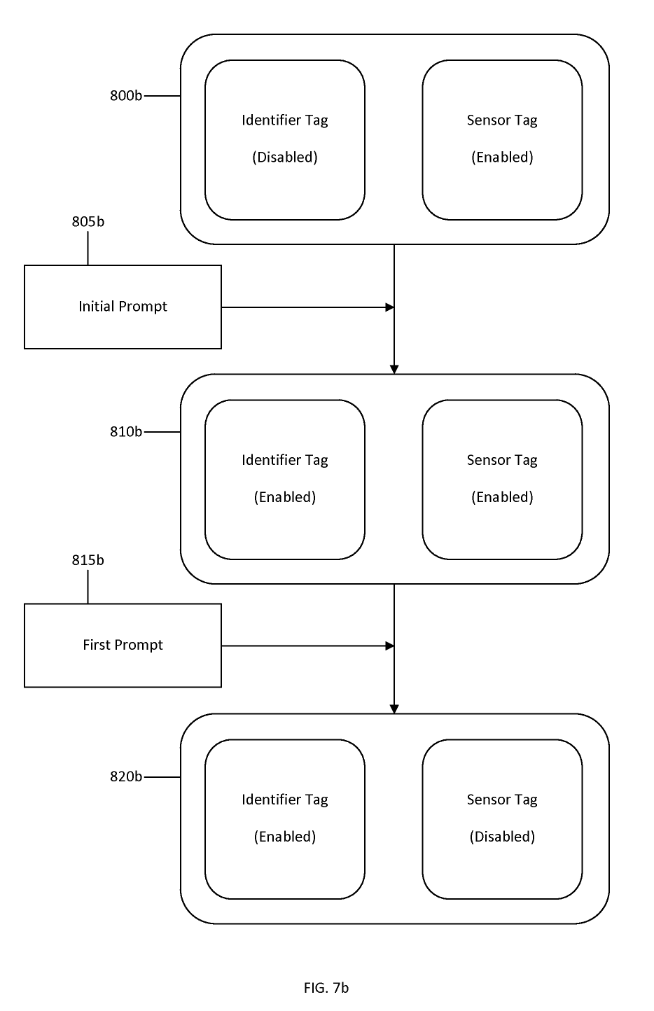

FIG. 7a shows a possible embodiment of a method of the present invention. In this embodiment, an embodiment of a RFID Sensor Assembly of the present invention exists in a first state whereby its identifier tag is enabled (capable of transmitting a signal), and its sensor tag is also enabled (capable of transmitting a signal), as shown in step 810a. A first prompt 815a (e.g., physical action, temperature above a particular threshold) causes the RFID Sensor Assembly to transition to a second state whereby its identifier tag remains enabled and its sensor tag is disabled (incapable of transmitting a signal), as shown in step 820a. An example of a practical application of this particular method is its use relative to an embodiment of a RFID Sensor Assembly as shown in FIG. 5. Such an embodiment of a RFID Sensor Assembly may indicate its identity by means of its identifier tag (always capable of transmitting a signal in this example), and its state by means of whether its sensor tag is enabled (capable of transmitting a signal) or disabled (incapable of transmitting a signal). Continuing with this example, a RFID Sensor Assembly having a sensor tag that is enabled may indicate that a seal of a container is intact, while a sensor tag that is disabled may indicate that a seal of a container has been compromised, for example.

FIG. 7b shows a possible embodiment of a method of the present invention. In this embodiment, an embodiment of a RFID Sensor Assembly of the present invention exists in an initial state whereby its identifier tag is disabled (incapable of transmitting a signal) and its sensor tag is enabled (capable of transmitting a signal), as shown in step 800b. An initial (e.g., pre-first) prompt 805b (e.g., an operator turning such a RFID Sensor Assembly on, meaning enabling both tags, for example) causes the RFID Sensor Assembly to transition to a first state whereby its identifier tag is enabled, and its sensor tag is also enabled, as shown in step 810b. A first prompt 815b (e.g., physical action, temperature above a particular threshold) causes the RFID Sensor Assembly to transition to a second state whereby its identifier tag remains enabled and its sensor tag is disabled (incapable of transmitting a signal), as shown in step 820b. An example of a practical application of this particular method is its use relative to an embodiment of a RFID Sensor Assembly as shown in FIG. 5. Such an embodiment of a RFID Sensor Assembly may first be transitioned from a “turned off” state (when only its sensor tag is capable of transmitting a signal and may indicate an identity of such a sensor assembly) to a “turned on” state (when both tags are enabled and capable of transmitting a signal). In this state, such a RFID Sensor Assembly may indicate its identity by means of its identifier tag signal, and may also indicate its state by means of whether its sensor tag is enabled (capable of transmitting a signal) or disabled (incapable of transmitting a signal). Continuing with this example, a RFID Sensor Assembly having a sensor tag that is enabled may indicate that a seal of a container is intact, while a sensor tag that is disabled may indicate that a seal of a container has been compromised, for example.

Another example of a possible embodiment implemented according to the present invention includes two tags that “swap” functionality, meaning one is enabled (capable of transmitting a signal) while the other is disabled (incapable of transmitting a signal), and subsequently, following a prompt, they swap states. For example, such an embodiment may have a first RFID tag that is enabled while Condition X is met, and a second RFID tag that is disabled while Condition X is met, with the tags swapping roles when Condition X is not met such that the first RFID tag is disabled while Condition X is not met, and the second RFID tag is enabled while Condition X is not met. Such an embodiment provides an assembly that uses two tags, in combination, to provide information about the presence of the assembly (since one tag is always functioning as an identifier tag and transmitting a signal), while communicating information about whether (or not) Condition X is met by virtue of the configuration, i.e., whether the first tag is enabled and second tag is disabled, or the first tag is disabled and the second tag is enabled. Swaps may be unidirectional or bidirectional. Condition X may be any of a variety of prompts, including but not limited to a physical or mechanical input (e.g., door open or closed, container secure or not, force on a mobile asset exceeding 10 g's or not, etc.), as well as prompts relating to temperature, time, and the presence of various chemical or biological agents, or radiation. FIG. 8 shows one possible embodiment of a method of the present invention that relates to a two-tag “swap function” embodiment of a RFID Sensor Assembly of the present invention whereby the tags swap functionality to communicate data about the identity of a tag and a condition. In FIG. 8, a sensor 900a has a first RFID tag 901a and second RFID tag 902a. Sensor 900b is the same sensor as sensor 900a, but exists in a different “state.” Sensor 900b has a first RFID tag 901b and a second RFID tag 902b. When Condition X is met, as represented by step 925, sensor 900a first RFID tag is enabled 901a (capable of transmitting a signal) and second RFID tag is disabled 902a (incapable of transmitting a signal). When Condition X is not met, as represented by step 975, sensor 900b first RFID tag is disabled 901b and second RFID tag is enabled 902b. This permits such an embodiment to be capable of continuously transmitting information about the presence of such a sensor within a space being read by a RFID reader system, and also provides information relating to Condition X (whether or not it has been met). Similar to other embodiments implemented according to the present invention, this embodiment may vary with regard to the RFID tag technologies being used (e.g., printed, chipless), the type of prompt that is being sensed, the number of tags used in a particular assembly (more tags permits transmission of more complex signals in order to communicate additional data, or higher fidelity of the same data), and more. Variants of a “swap sensor” embodiment of the present invention implemented according to the method described above may be useful to monitor portable objects that may or may not be in a location or position of interest, such as an asset that is temporary or frequently moved around, yet benefits from inclusion of one or more sensors. A single prompt may cause a condition to be met, or not to be met, in response to which both tags may change state, e.g., a first tag may change from enabled to disabled and a second tag may change from disabled to enabled, or vice versa.

As another example of a practical application of a RFID Sensor Assembly of the present invention, a sensor tag may sense if it has been exposed to a prompt above some predefined temperature threshold. Such a RFID Sensor Assembly may be useful in association with a perishable food product, such as meat or ice cream, which may be compromised if allowed to go above a certain temperature. Such a RFID Sensor Assembly could also be used for certain refrigerated drugs, proteins, or medical materials. For example, a sensor tag of such an embodiment may be enabled to transmit its signal initially, when the temperature is below the established temperature threshold, and may become disabled and cease being capable of transmitting its signal if the temperature rises above the established temperature threshold. In this instance, the RFID Sensor Assembly will transmit signals from both its identifier tag and sensor tag, provided that the temperature has remained below the established temperature threshold. If, on the other hand, the RFID Sensor Assembly sensor tag experiences a temperature above the established temperature threshold, then its sensor tag will become disabled and stop transmitting, and only the identifier RFID tag will be detectable.

Another example of an embodiment of a RFID Sensor Assembly of the present invention relates to a sensor tag that transitions from one state to another (e.g., becomes capable of transmitting its signal, or not, respectively) after a predetermined lapse of time. For example, a sensor tag of this embodiment may become disabled and no longer be able to transmit its signal after a certain amount of lapsed time, such as five days. Such an embodiment of a RFID Sensor Assembly of the present invention may be practical for use with perishable food or medical products, for example.

As yet another example of a practical application of a RFID Sensor Assembly of the present invention, the RFID Sensor Assembly may be associated with another (e.g., external) device, such as a biochip, that is capable of detecting a condition such as the presence of a particular molecule. Another example of an external sensing device is a radiation detector. A sensor tag may be designed and made to respond to an external signal and to transition from one state to another based on such external input.

Many other practical applications of a RFID Sensor Assembly of the present invention are possible and anticipated herein. These other applications may relate to a determination of whether a particular RFID Sensor Assembly sensor tag has been exposed to a particular prompt. A prompt may relate to a physical or mechanical force, temperature, pressure, vibration, time lapse, environmental exposure, input from an external device, and more. Furthermore, such applications may relate to a wide range of objects with which RFID Sensor Assemblies may be associated (e.g., attached to, printed onto). Objects include, but are not limited to: containers, locks, tape, packaging, pallets, perishable products, people, and more.

A first advantage of embodiments of the present invention is that they provide sensor assemblies that combine two or more RFID tags. Embodiments may, for example, include an identifier tag, plus one or more sensor tags that are each responsive to a particular prompt (or prompts). This is advantageous because it enables the use of two or more inexpensive (e.g., chipless) RFID tags in place of an expensive “smart” tag (e.g., a tag with a battery and microprocessor). For example, such embodiments may be more cost-effective and simpler to implement relative to current alternatives. Additionally, tags that do not include integrated circuits may be able to operate and survive in extreme conditions (e.g., radiation prone environments, high temperatures) and can provide advantages for certain applications.

Another advantage of embodiments of the present invention is that they provide sensor assemblies that can be made to sense and communicate data relating to any of a variety of prompts. Embodiments of the present invention provide for this advantage by making use of a sensor chip that is designed and manufactured to detect a prompt of interest, or that may receive input from another device (e.g., an external sensor device) or associated component. For example, in one embodiment of the present invention, a sensor tag may be sensitive to physical disruption or breakage of either the sensor tag or a device or structure that the sensor tag is associated with. In another possible embodiment, a sensor tag is capable of determining temperature rise above a predetermined threshold. In another embodiment of the present invention, an external chemical sensor may detect the presence of a certain chemical in an environment and then communicate with a sensor tag of the present invention. In each of these examples, an embodiment of a Sensor Assembly of the present invention uses two or more RFID tags to communicate both the identity and state of the particular RFID Sensor Assembly.

Another advantage of embodiments of the present invention is that they provide for sensor assemblies that combine chipless RFID tag technology to provide novel and significant functionality that cannot be provided by a single chipless RFID tag alone. Whereas a single tag my provide information about the identity of a tag (and associated object), a RFID Sensor Assembly of the present invention that utilizes two or more tags may provide information relating to both an identity and state of a tag and object. In addition, as noted above, chipless tags may provide operational advantages in certain environments. Chipless tags, including printed chipless tags, are also relatively less expensive that tags that include a microprocessor, and thereby provide a cost advantage which enables more practical applications.

Another advantage of embodiments of the present invention is that they provide for sensor assemblies that enable two or more printed RFID tags to be used to communicate object identity and object status information. Since printed RFID technology is likely to be utilized to a greater extent due to its low cost and ability to be printed directly onto the surface of objects, and since such printed RFID techniques (or applications) may not be conducive to inclusion of microprocessors for technical or cost reasons, the ability to combine simple (e.g., binary) tags that either transmit or not, to provide a binary signal from each distinct tag, enables complex sensing to be performed using simple, low-cost printed technology. By providing Sensor Assemblies with an identifier tag, and one or more sensor tags, printed RFID technologies and techniques enable embodiments of Sensor Assemblies of the present invention to be implemented in quantity and at low cost for a wide range of useful purposes.

Another advantage of embodiments of the present invention is that they provide sensor assemblies that may be associated with a container seal, either in a permanent, semi-permanent, or detachable manner. For example, an embodiment of the present invention may be attached (e.g., adhered) to a container (e.g., package, box, carton, envelope, sealable bag) to enable a smart container that may communicate information about both its identity (by means of an identifier tag of a sensor assembly, for example) and whether or not it has been opened, e.g., if a seal of the container has been opened or disrupted, (by means of a sensor tag of the same sensor assembly, for example). This provides many benefits relative to the monitoring of such containers. Such embodiments may be attached to the surface of a container using any of a variety of attachment means, may be constructed into the material of a container, or may be secured to a container using a loop or other attachment means. It is also possible to create seals that combine existing sealing technologies, such as locks or tape, with RFID sensor assemblies of the present invention, to provide novel products and methods having associated advantages.

Another advantage of embodiments of the present invention is that they provide RFID sensor systems and methods that are cost-effective and relatively simple to make and use for a variety of applications.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

For example, embodiments of the invention may utilize either passive or active RFID technology, and tags may be readable by a wide range of compatible readers. RFID Sensor Assemblies may also detect any of a wide range of inputs, either directly, or by means of an external sensor device that provides input to a sensor tag of a RFID Sensor Assembly. A RFID Sensor Assembly may include one or more sensor tags. The tags that make up a RFID Sensor Assembly may be physically connected, or distributed, and may share common components. The range of possible prompts or inputs that may be detected by a particular RFID Sensor Assembly by virtue of its sensor tag(s) may also vary significantly, depending on the purpose and construction of a particular sensor tag and what it is capable of sensing. Some sensor tags may sense only one prompt or input, whereas other sensor tags may be constructed to sense multiple inputs, possibly in combination. A RFID Sensor Assembly of the present invention may also communicate information in a variety of ways. First, individual tags may be passive or active, and may operate on any of a wide range of RFID frequencies. Printed and chipless tags are of particular use for embodiments of the present invention due to their cost-effectiveness and ability to be implemented widely for a range of practical applications. Second, a particular RFID Sensor Assembly may communicate information relating to its state in a variety of ways. For example, a RFID Sensor Assembly having only two RFID tags (a first identifier tag that identifies the assembly and a second sensor tag that serves as a sensor and changes state, e.g., its ability to transmit a signal) may communicate its state in binary fashion—if the sensor tag is transmitting it means one thing; if the sensor tag is not transmitting it means another thing. It is consistent with the present invention that a RFID Sensor Assembly may include multiple sensor tags that sense the same or different things, and that communicate information independently. In this manner, it is possible for a RFID Sensor Assembly of the present invention to communicate multiple parameters, or to communicate various levels of the same parameter, to a RFID tag reader and associated system. These are a few examples of variations of the present invention; other variations are possible and are anticipated by the present disclosure.

Elements and components described herein may be further divided into additional components or joined together to form fewer components for performing the same functions.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, for example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A radio frequency identification (RFID) sensor assembly comprising:
a first RFID tag comprising first means for transmitting a first signal representing an identity of the first RFID tag;
a second RFID tag comprising:
means for transitioning the second RFID tag from a first state to a second state in response to receipt of a first prompt by the second RFID tag;
second means for transmitting a second signal, representing an identity of the second RFID tag and differing from the first signal, only when the second RFID sensor tag is in a predetermined one of the first and second states.

2. The sensor assembly of claim 1, wherein the first state is the predetermined one of the first and second states.

3. The sensor assembly of claim 1, wherein the second state is the predetermined one of the first and second states.

4. The sensor assembly of claim 1, wherein the first RFID tag comprises a RFID tag selected from the group consisting a passive RFID tag, a printed RFID tag, and a chipless RFID tag.

5. The sensor assembly of claim 1, wherein the second state comprises a state in which the second means for transmitting is incapable of transmitting the second signal.

6. The sensor assembly of claim 1, wherein the second state comprises a state in which the second means for transmitting is capable of transmitting the second signal.

7. The sensor assembly of claim 1, wherein the first prompt comprises a mechanical action applied to the second RFID tag.

8. The sensor assembly of claim 1, wherein the first prompt comprises a prompt selected from the group consisting of an electrical signal applied to the second RFID tag, a chemical action applied to the second RFID tag, and a temperature-related action applied to the second RFID tag.

9. The sensor assembly of claim 1, wherein the first prompt comprises a prompt selected from the group consisting of a lapse of a predetermined amount of time, and an occurrence of a predetermined point in time.

10. The sensor assembly of claim 1, further comprising:
a third RFID tag comprising:
means for transitioning the third RFID sensor tag from a third state to a fourth state in response to receipt of a second prompt by the third RFID tag; and
third means for transmitting a third signal, representing an identity of the third RFID tag, only when the third RFID sensor tag is in a predetermined one of the third and fourth states.

11. The sensor assembly of claim 1, wherein the second RFID tag further comprises:
means for transitioning the second RFID tag from the second state to the first state in response to receipt of a second prompt by the second RFID tag.

12. The sensor assembly of claim 1:
wherein the first state is the predetermined one of the first and second states;
wherein the first RFID tag further comprises means for transitioning the first RFID tag from a third state to a fourth state in response to receipt of a second prompt by the first RFID tag;
wherein the first means for transmitting comprises means for transmitting the first signal only when the first RFID tag is in the fourth state.

13. The sensor assembly of claim 12, wherein the first and second prompts are the same prompt.

14. The sensor assembly of claim 1:
wherein the second state is the predetermined one of the first and second states;
wherein the first RFID tag further comprises means for transitioning the first RFID tag from a third state to a fourth state in response to receipt of a second prompt by the first RFID tag;
wherein the first means for transmitting comprises means for transmitting the first signal only when the first RFID tag is in the third state.

15. The sensor assembly of claim 14, wherein the first and second prompts are the same prompt.

16. The sensor assembly of claim 1, further comprising:
a container coupled to the second RFID tag, comprising means for applying the first prompt to the second RFID tag in response to an action applied to the container.

17. A method performed by a RFID sensor assembly, the RFID sensor assembly comprising a first RFID tag and a second RFID tag, the method comprising:
(A) at the first RFID tag, transmitting a first signal representing an identity of the first RFID tag;
(B) at the second RFID tag, transmitting a second signal, representing an identity of the second RFID tag and differing from the first signal;
(C) transitioning the second RFID tag into a second state in response to receipt of a first prompt by the second RFID tag; and
(D) at the second RFID tag, while the second RFID tag is in the second state, not transmitting the second signal.

18. The method of claim 17, wherein (C) comprises mechanically disabling the second RFID tag.

19. A method performed by a RFID sensor assembly, the RFID sensor assembly comprising a first RFID tag and a second RFID tag, the method comprising:
(A) at the first RFID tag, transmitting a first signal representing an identity of the first RFID tag;
(B) at the second RFID tag, not transmitting a second signal representing an identity of the second RFID tag and differing from the first signal;
(C) transitioning the second RFID tag into a second state in response to receipt of a first prompt by the second RFID tag; and
(D) at the second RFID tag, while the second RFID tag is in the second state, transmitting the second signal.

20. An apparatus comprising:
first signal reception means for receiving a first signal from a first RFID tag of a RFID sensor assembly, the first signal representing an identity of the first RFID tag;
means for determining whether the first signal reception means has received the first signal;
second signal reception means for receiving a second signal from a second RFID tag of the RFID sensor assembly;
means for determining whether the second signal reception means has received the second signal;
means for identifying a state of the RFID sensor assembly comprising:
means for concluding that the RFID sensor assembly is in a first state if the first signal reception means has received the first signal and the second signal reception means has received the second signal; and
means for concluding that the RFID sensor assembly is in a second state that differs from the first state if the first signal reception means has received the first signal and the second signal reception means has not received the second signal.

21. A method performed by an apparatus, the method comprising:
(A) determining whether a first signal, representing an identity of a first RFID tag, has been received by a RFID interrogator device;
(B) determining whether a second signal, representing an identity of a second RFID tag and differing from the first signal, has been received by the RFID interrogator device;
(C) concluding that a RFID sensor assembly associated with the first RFID tag and the second RFID tag is in a first state if the RFID interrogator device has received the first signal and the second signal; and
(D) concluding that the RFID sensor assembly associated with the first RFID tag and the second RFID tag is in a second state that differs from the first state if the RFID interrogator device has received the first signal and has not received the second signal.
